(19) United States
(12) Patent Application Publication
(10) Pub. No.: US 2016/0258592 A1
(43) Pub. Date: Sep. 8, 2016

(54) LIGHTING APPARATUS

(71) Applicant: KABUSHIKI KAISHA TOSHIBA, Tokyo (JP)

(72) Inventor: Reiji ONO, Yokohama Kanagawa (JP)

(21) Appl. No.: 14/819,022

(22) Filed: Aug. 5, 2015

(30) Foreign Application Priority Data
Mar. 4, 2015 (JP) 2015-042402

(51) Int. Cl. F21V 3/04; F21V 3/02; G09B 27/04; F21K 99/00

(52) U.S. Cl. CPC F21V 3/049; F21K 9/56; F21V 3/02; G09B 27/04; F21Y 2101/02

(57) ABSTRACT

A lighting apparatus includes an LED, a diffusion member, and a light shielding member. The diffusion member is disposed so as to at least partially cover the LED and diffuses light emitted from the LED. The light shielding member is disposed so as to at least partially cover the diffusion member and is provided with a plurality of pinholes through which light diffused by the diffusion member is transmitted. In some example embodiments, the light apparatus can be a planetarium apparatus for projecting star images such as constellations or the like.

### CROSS-REFERENCE TO RELATED APPLICATION

This application is based upon and claims the benefit of priority from Japanese Patent Application No. 2015-042402, filed Mar. 4, 2015, the entire contents of which are incorporated herein by reference.

### FIELD

Exemplary embodiments described herein relate to a lighting apparatus.

### BACKGROUND

As a method for projecting a star image using a small-sized planetarium apparatus, the following two methods are known. In a first method, a plurality of lenses is used to focus light from a light source onto a constellation (star field) plate. The light transmitted through the constellation plate is then projected onto the planetarium screen (e.g., dome). In a second method, a plurality of projection holes are formed in the constellation plate and are used as pinhole lenses, whereby the light is projected without first focusing (collecting) the light from the light source.

In the pinhole lens type planetarium apparatus for which the second method is used, a substantially semispherical constellation plate covering the light source is used and the plurality of projection holes are formed over an entire surface of the constellation plate, whereby the star image is projected outwardly.

However, in the pinhole lens type planetarium apparatus, the shape of the light source used for projection affects projection results and quality.

### DESCRIPTION OF THE DRAWINGS

FIG. 1 is a longitudinal cross-sectional view of a planetarium apparatus according to a first embodiment.

FIG. 2 is a top view of a light source unit in the planetarium apparatus of FIG. 1.

FIG. 3 is a longitudinal cross-sectional view of the light source unit which is taken along line A-A of FIG. 2.

FIG. 4 is a top view of a light source unit according to a second embodiment.

FIG. 5 is a longitudinal cross-sectional view of the light source unit which is taken along line B-B of FIG. 4.

FIG. 6 is a perspective view illustrating an external appearance of a planetarium apparatus according to a third embodiment.

FIG. 7 is a top view of a light source unit in the planetarium apparatus of FIG. 6.

FIG. 8 is a longitudinal cross-sectional view of the light source unit which is taken along line C-C of FIG. 7.

FIG. 9 is a longitudinal cross-sectional view of a light source unit according to a fourth embodiment.

FIG. 10 is a longitudinal cross-sectional view of a planetarium apparatus of a comparative example.

### DETAILED DESCRIPTION

An embodiment provides a lighting apparatus having improved projection performance.

According to one embodiment, a lighting apparatus includes an LED, a diffusion member, and a light shielding member. The diffusion member is disposed so as to at least partially cover the LED and diffuses light emitted from the LED. The light shielding member is disposed so as to at least partially cover the diffusion member and is provided with a plurality of pinholes through which light diffused by the diffusion member can be transmitted.

Hereinafter, exemplary embodiments will be described with reference to the drawings. The exemplary embodiments are for purposes of explanation and are not intended to limit the scope of the disclosure to the specific examples.

### First Embodiment

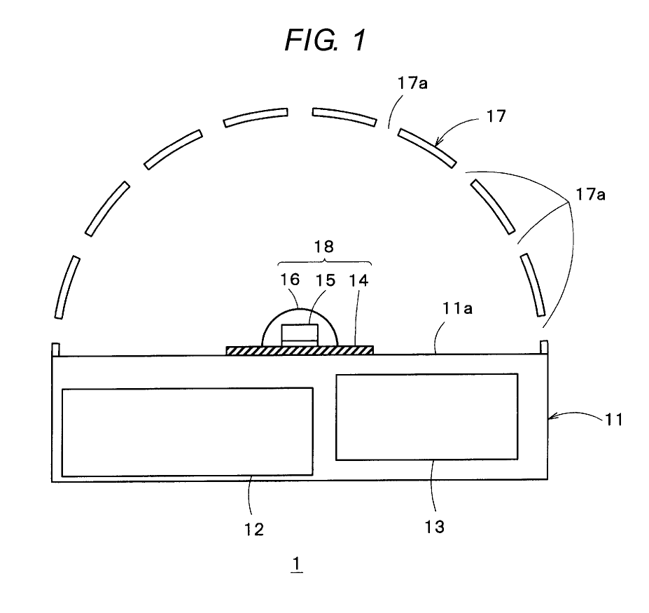

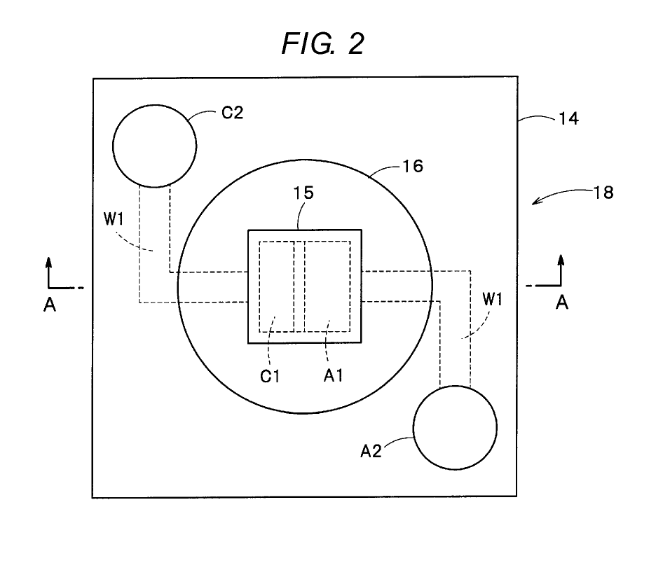

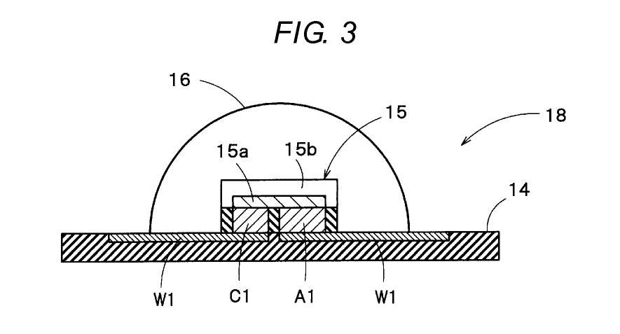

FIG. 1 is a longitudinal cross-sectional view of a planetarium apparatus (lighting apparatus) 1 according to a first embodiment. FIG. 2 is a top view of a light source unit 18 in the planetarium apparatus 1 depicted in FIG. 1. FIG. 3 is a longitudinal cross-sectional view of the light source unit 18 which is taken along line A-A of FIG. 2.

For example, the planetarium apparatus 1 is installed in a room of a house. As illustrated in FIG. 1, the planetarium apparatus 1 includes a base 11 (e.g., base table), a battery box 12, a power supply circuit 13, a light emitting diode (LED) mounting substrate 14, a light emitting diode (LED) light source 15, a diffusion member 16, and a light shielding member 17. The LED mounting substrate 14, the LED light source 15, and the diffusion member 16 function here as the light source unit 18.

The battery box 12 and the power supply circuit 13 are accommodated in the base 11. Power is supplied from the battery box 12 to the power supply circuit 13. The base 11 has a support surface 11a supporting the LED light source 15, the diffusion member 16, and the light shielding member 17. The LED mounting substrate 14 is provided at (or substantially at) a center of the support surface 11a of the base 11. For simplicity, in the specification, a direction perpendicular to the support surface 11a of the base table 11 may be referred to as a vertical direction and a direction parallel to the support surface 11a may be referred to as a horizontal direction.

The LED mounting substrate 14 supports the LED light source 15 and the diffusion member 16. The LED light source 15 is mounted at (or substantially at) a center of an upper surface of the LED mounting substrate 14.

For example, the LED light source 15 may be a rectangular parallelepiped shape that emits white light. A correlated color temperature of the white light may be, for example, 1,500 K to 10,000 K.

As illustrated in FIG. 3, the LED light source 15 has a light emitting layer 15a, a sealing layer 15b covering the light emitting layer 15a, an anode electrode A1, and a cathode electrode C1 which are electrically connected to the light emitting layer 15a. The sealing layer 15b is formed of a transparent resin or the like. It should be noted that in FIG. 1 and FIG. 3, cross sections of the LED mounting substrate 14 and the LED light source 15 are presented in a simplified manner and various components or features may be present.

The anode electrode A1 is connected to an anode electrode A2 formed on the LED mounting substrate 14 through a wiring pattern W1 formed on the LED mounting substrate 14. The cathode electrode C1 is connected to a cathode electrode C2 formed on the LED mounting substrate 14 through the wiring pattern W1 formed on the LED mounting substrate 14. The anode electrode A2 and the cathode electrode C2 are electrically connected to the power supply circuit 13. Thus, a current is supplied from the power supply circuit 13 to the LED light source 15.

The diffusion member 16 is disposed on the LED mounting substrate 14 so as to at least partially cover the LED light source 15. In the illustrated example, the diffusion member 16 is disposed so as to entirely cover the LED light source 15. As depicted, the diffusion member 16 has a shape of a generally spherical dome surface and is vertically convex. In the illustrated example, the diffusion member 16 has a shape of a substantially semispherical (hemispherical) surface, but the shape of diffusion member 16 is not limited to this, and the diffusion member 16 may have for example a shape which is less than the semispherical surface and need not be fully symmetrical when viewed from a vertical direction. The diffusion member 16 can be, for example, formed of a transparent silicon-based resin containing a diffusing material that diffuses light and specifically diffuses the light emitted from the LED light source 15.

The light shielding member (constellation plate) 17 is disposed on the base 11 so as to at least partially cover the LED mounting substrate 14, the LED light source 15, and the diffusion member 16. In the illustrated example, the light shielding member 17 is disposed so as to entirely cover the LED mounting substrate 14, the LED light source 15, and the diffusion member 16. A shape of the light shielding member 17 is, for example, a dome shape, but is not limited to this. A plurality of pinholes (transmission holes and projection holes) 17a for transmitting the light diffused by the diffusion member 16 is formed in the light shielding member 17. Those portions of the light shielding member 17 other than the pinholes 17a are opaque and do not transmit light. The pinhole 17a functions as a pinhole lens. In some examples, the light shielding member 17 may be formed of a black resin and the pinhole 17a may be formed of a transparent resin. Thus, as used herein “pinhole” need not be an actual hole formed in the light shielding member 17, but rather also includes transparent portions disposed or otherwise formed in light shield member 17.

The light transmitted through the plurality of pinholes 17a is projected on a projection surface such as a wall and/or ceiling surface (not illustrated). Here, the plurality of pinholes 17a is provided at positions corresponding to a disposition of stars in, for example, a nighttime sky. The pinhole 17a positions correspond here to star positions as viewed from some fixed position on Earth, for example. An observer may thus observe a star image projected on the projection surface.

The light emitted from the rectangular LED light source 15 is diffused by the diffusion member 16 covering the LED light source 15. Thus, for example, when viewed from the vertical direction, the diffusion member 16 (with LED light source 15 therein) has a substantially circular shape. The pinhole 17a projects a shape of the light emitting source used for the projecting on the projection surface. Here, the apparent light emitting source has the substantially circular shape, due to the presence of diffusion member 16 covering the LED light source 15). Thus, the light projected from the pinhole 17a also has a substantially circular shape. Thus, an appearance of the projected starry sky is improved.

Furthermore, as illustrated in FIG. 3, the LED light source 15 has a package structure without an envelope—that is, the packaging of the LED light source 15 does not include any portion that shields/blocks light that might be emitted along a horizontal direction. Thus, the LED light source 15 can have a light distribution characteristic such that light is also emitted in a substantially horizontal direction (plane direction of the support surface 11a). That is, a light distribution angle of the LED light source 15 is approximately 180 degrees or greater. The planetarium apparatus 1 may thus project the star image in a substantially horizontal direction. Moreover, when observing the diffusion member 16 from the horizontal direction, since the diffusion member 16 is observed as a substantially semicircular shape, the light projected in the horizontal direction also has a substantially semicircular shape.

However, a diameter of the projected star image is obtained by the following Expression (1):

diameter of the star image=area of LED light source×(distance to projection surface−diameter of projector)/diameter of projector.

In Expression (1), the distance to the projection surface may be taken to be a distance from the center of the LED light source 15 to the projection surface. The diameter of projector can be set to two times (2×) the distance from the center of the LED light source 15 to the light shielding member 17.

A possible method for improving the appearance of the projected starry sky would be to increase the number of the projected star images in the starry sky. However, as illustrated in the Expression (1), if a size of the LED light source 15 is increased, the projected star image is also increased and a phenomenon in which the star images overlap with each other in the projection surface occurs.

For example, in a comparative example not including a diffusion member 16, if the distance to the projection surface is 1.5 m, the diameter of the projector is 0.2 m, and the number of the star images is 10,000, in order to project sharp star images without allowing the star images to overlap each other on the projection surface, the size of the LED light source would need to be approximately 1 mm×1 mm. Thus, it is preferable to use an LED light source having a size of 1 mm×1 mm or less to prevent overlapping star images in this example.

However, as described above, according to an example embodiment, the light emitted from the LED light source 15 is diffused by the diffusion member 16 and the diffused light is transmitted through the pinhole 17a rather than light directly from the LED light source 15. Thus, the shape of the star image projected on the projection surface is a shape corresponding to a surface shape of the diffusion member 16 without specifically depending on the shape of the LED light source 15. Since the surface shape of the diffusion member 16 is substantially semispherical, the diffusion member 16 is observed as a substantially circular shape when viewed from the many directions from a projection surface side. Thus, substantially circular star images are projected for the many positions on the projection surface. Thus, the projected images look like an actual starry sky and it is possible to improve projection performance by incorporation of diffusion member 16 or a similar structure.

Here, a planetarium apparatus 1X according to a comparative example will be described.

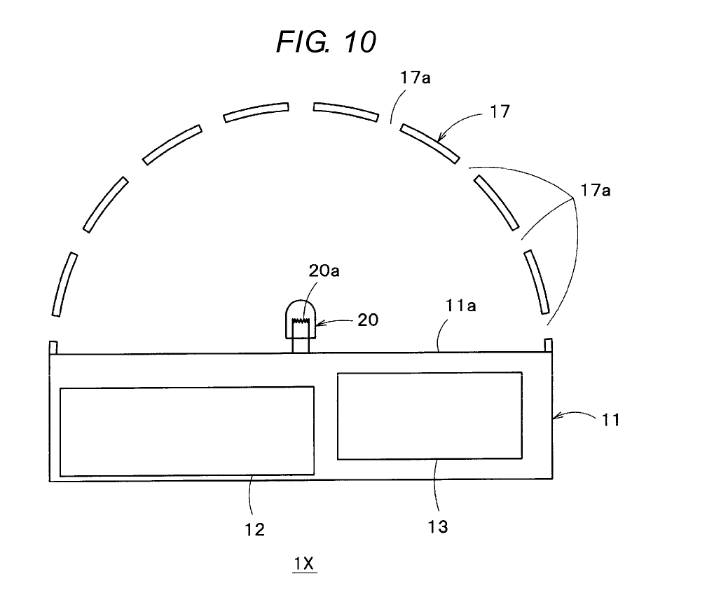

FIG. 10 is a longitudinal cross-sectional view of the planetarium apparatus 1X according to the comparative example. In the comparative example, a filament bulb 20 is provided instead of the light source unit 18 (see FIG. 1). In this case, the shape of the projected star image is close to a shape of a filament 20a in the filament bulb 20. Thus, the projected image is unlikely to be viewed as a realistic twinkling star, but rather will correspond in appearance to the filament 20a.

Furthermore, as described above, since the sharp star image is not obtained if the light source is not sufficiently small relative to the pinhole 17a, when using a typical filament bulb 20, the star image becomes too large as the filament 20a necessary to provide sufficient light for purposes of projection is typically large. Furthermore, since the life of the filament 20a is relatively short, it is necessary to frequently replace the filament bulb 20 with new one.

If only the LED light source 15 (without the diffusion member 16) was used in place of the filament bulb 20, then the rectangular shape of the LED light source 15 would be projected on the projection surface, thus a substantially rectangular star image would be projected. In this case, the projected image would be unlikely to be viewed as a realistic twinkling star.

As described above, according to the first embodiment, such problems as present in the comparative examples may be solved.

### Second Embodiment

In a second embodiment, a shape of a diffusion member 16A is different from that of the diffusion member 16 in the first embodiment.

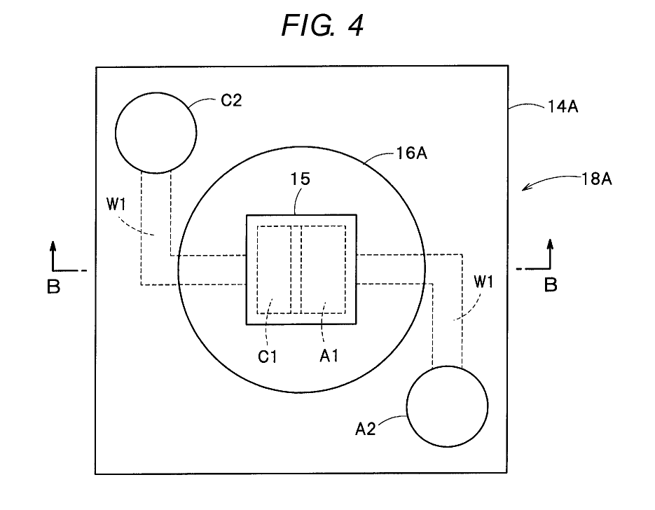

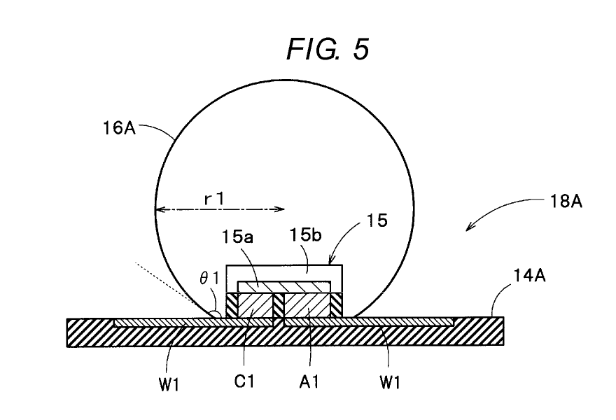

FIG. 4 is a top view of a light source unit 18A according to the second embodiment. FIG. 5 is a longitudinal cross-sectional view of the light source unit 18A which is taken along line V-V of FIG. 4. In FIGS. 4 and 5, the same reference numerals are given to the same components as those of FIGS. 2 and 3, and the following description of the second embodiment will focus primarily on differences with the first embodiment. In general, the configuration of the corresponding planetarium apparatus of the second embodiment other than the configuration of light source unit 18A in FIG. 5 is the same as planetarium apparatus of the first embodiment.

The diffusion member 16A has a shape of a part of a substantially spherical surface wider than the semi-spherical surface. That is, a height of the diffusion member 16A in a vertical direction is greater than a radius r1 of a sphere. As described above, an entire shape of the diffusion member 16A is in a form which is obtained by cutting a lower portion of the sphere with a plane. A surface of the diffusion member 16A is closer to the spherical surface than the diffusion member 16 according to the first embodiment. That is, diffusion member 16A is closer to being a full sphere shape than the diffusion member 16, which is hemispherical (a half sphere shape) or less than hemispherical (less than a half spherical shape).

At least a region of an LED mounting substrate 14A coming in contact with the diffusion member 16A has a hydrophobic property.

For example, the diffusion member 16A may be formed by using the following forming method.

First, the LED mounting substrate 14A of which a surface has the hydrophobic property is prepared. The hydrophobic property may be given to a hydrophilic surface of the LED mounting substrate 14A by applying a hydrophobic agent such as a fluorine-based or Teflon-based coating agent thereto.

Next, a transparent silicon-based resin containing a diffusion material is potted on the surface of the LED mounting substrate 14A. The resin material has a contact angle θ1 with the LED mounting substrate 14A that is greater than 90 degrees. It is preferable because a shape of potted resin is closer to a spherical shape as the contact angle θ1 is increases. Thus, as illustrated in FIG. 5, the resin has the shape that is formed by cutting the lower portion of the sphere with the plane. The diffusion member 16A is subsequently formed by curing the resin.

According to the second embodiment, since the surface of the diffusion member 16A is closer to the spherical surface compared to the first embodiment, the diffusion member 16A is observed as a substantially circular shape from more directions than the first embodiment. That is, the diffusion member 16A is observed as the substantially circular shape even when observed in a direction close to the horizontal direction. Thus, the planetarium apparatus 1 may project substantially circular light even in a substantially horizontal direction. Thus, the substantially circular light is projected to more, positions of the projection surface than the first embodiment and it is possible to further improve projection performance compared to that of the first embodiment.

### Third Embodiment

In a third embodiment, shapes of a diffusion member 16B and a light shielding member 17B are different from corresponding elements of the first and second embodiments.

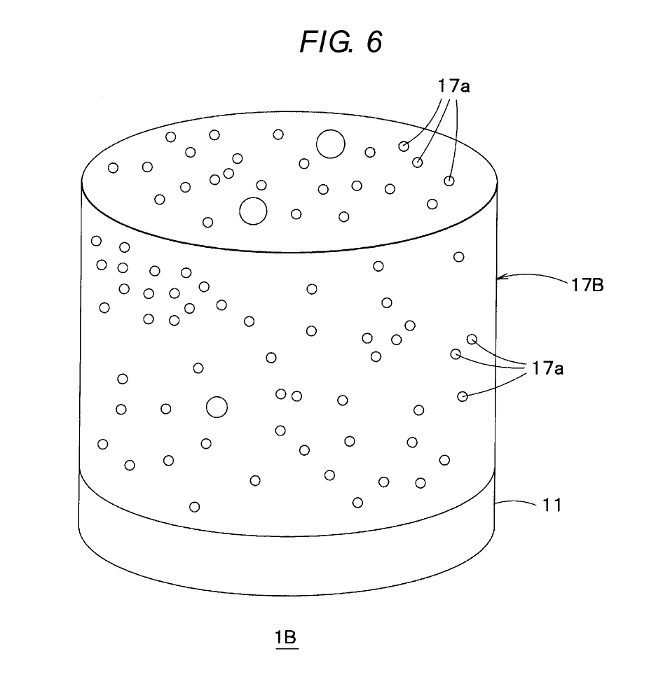

FIG. 6 is a perspective view illustrating an external appearance of a planetarium apparatus 1B according to the third embodiment. As illustrated in FIG. 6, an external shape of the light shielding member 17B is cylindrical. Similar to the first embodiment, a plurality of pinholes 17a through which the light is transmitted are formed on a side surface and an upper surface of the light shielding member 17B.

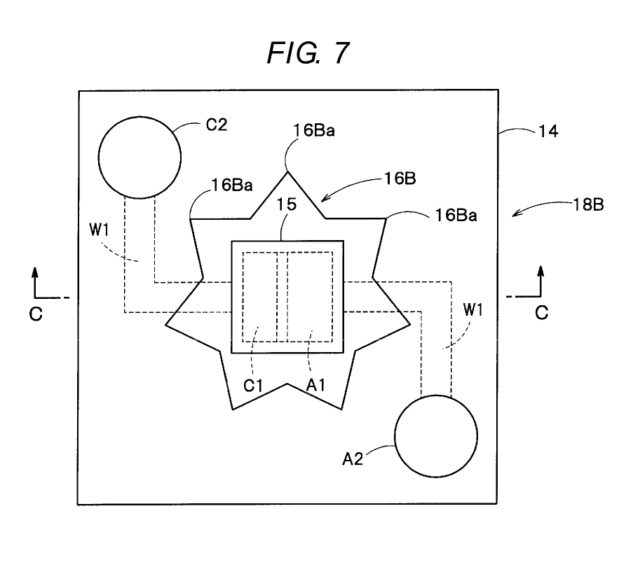

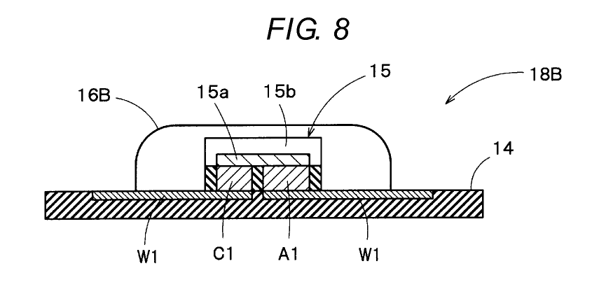

FIG. 7 is a top view of a light source unit 18B in the planetarium apparatus 1B of FIG. 6. FIG. 8 is a longitudinal cross-sectional view of the light source unit 18B which is taken along line VIII-VIII of FIG. 7. As illustrated in FIG. 7, the diffusion member 16B has a plurality of protrusion portions 16Ba. The number of protrusion portions 16Ba is not specifically limited, but seven are depicted in FIG. 7. The diffusion member 16B surrounds the rectangular LED light source 15 and has a star shape when viewed from the vertical direction. That is, the plurality of protrusion portions 16Ba protrude radially in different horizontal directions. For example, the diffusion member 16B is shaped in a star shape using a mold. In the illustrated example, a surface of the diffusion member 16B in the vertical direction is substantially flat.

According to the third embodiment, since the diffusion member 16B includes the plurality of protrusion portions 16Ba, the diffusion member 16B is observed in a shape close to a star shape, particularly from a vertical (or approximately vertical) direction. Thus, the light having a substantially star shape is projected on a projection surface that is positioned in the direction close to the vertical direction. Thus, the appearance of starry sky is improved, and it is possible to improve the projection performance.

Moreover, the protrusion portions 16Ba protruding in the vertical direction and the like may be further provided. That is, the upper surface of the diffusion member 16B is not required to be flat and one or more protrusion portions 16Ba may protrude in a vertical direction such that a horizontal profile (a vertical cross-section) of the diffusion member 16B may include protrusion portions 16Ba making at least a portion of star shape.

In addition, a shape of the light shielding member 17B is not limited to the cylindrical shape and may be a dome shape as the first embodiment or may be another shape.

### Fourth Embodiment

A fourth embodiment is different from the first embodiment in that a diffusion member 16C includes phosphors 19.

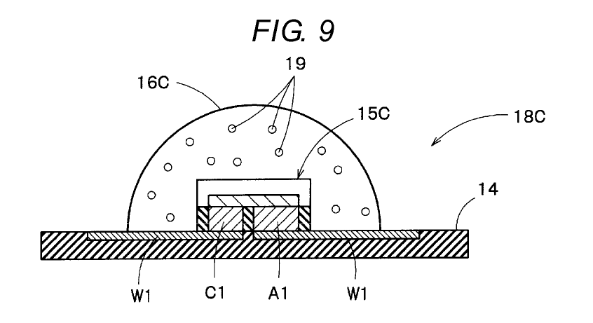

FIG. 9 is a longitudinal cross-sectional view of a light source unit 18C according to the fourth embodiment. FIG. 9 corresponds to FIG. 3. In FIG. 9, the same reference numerals are given to the same components as those of FIGS. 1 to 3, and description will be made below mainly on differences therebetween. Furthermore, the configuration of the planetarium apparatus according to the fourth embodiment other than the light source unit 18C is the same as that depicted in FIG. 1.

For example, an LED light source 15C emits light such as blue light other than the white light.

The diffusion member 16C includes a plurality of phosphors 19 which serve to emit the white light by absorbing light emitted from the LED light source 15C and re-emitting light at a different wavelength (or wavelengths). Thus, a star image is projected on a projection surface by the white light. A shape of the diffusion member 16C is the same as that of FIG. 1.

According to the fourth embodiment, since it is not necessary to use a white LED light source as the LED light source 15C, a degree of freedom in planetarium apparatus design is increased. It is possible to obtain the same effects as those of first embodiment with such a configuration.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting apparatus, comprising:
a light emitting diode;
a diffusion member at least partially covering the light emitting diode and configured to diffuse light emitted from the light emitting diode; and
a light shielding member that at least partially covers the diffusion member and is provided with a plurality of pinholes through which light diffused by the diffusion member is transmitted.

2. The lighting apparatus according to claim 1, wherein the diffusion member has an outer surface that is a portion of a sphere.

3. The lighting apparatus according to claim 2, wherein the outer surface of the diffusion member is a hemisphere.

4. The lighting apparatus according to claim 2, wherein the outer surface of the diffusion member is more than one half of the sphere.

5. The lighting apparatus according to claim 4, further comprising:
a base plate that supports the light emitting diode and the diffusion member, wherein
a region of the base plate contacting the diffusion member has a hydrophobic surface.

6. The lighting apparatus according to claim 1, wherein the diffusion member includes a plurality of protrusion portions and has a star-shape profile when viewed along at least one direction.

7. The lighting apparatus according to claim 1, wherein the pinholes in the plurality of pinholes are provided at positions corresponding to positions of stars.

8. The lighting apparatus according to claim 1, wherein the diffusion member includes a plurality of phosphors that absorb light emitted at a wavelength of light emitted by the light emitting diode and emit light at a different wavelength.

9. The lighting apparatus according claim 1, further comprising:
a base table having a support surface that supports the light emitting diode, the diffusion member, and the light shielding member, wherein
light from the light emitting diode is transmitted through the light shielding member in a direction parallel to the support surface.

10. The lighting apparatus according to claim 1, wherein the lighting apparatus is in a planetarium.

11. A planetarium apparatus, comprising:
a light emitting diode element mounted on a substrate including wiring and electrodes for providing electrical power to the light emitting diode;
a diffusion member that is translucent at a wavelength of light emitted by the light emitting diode, the diffusion member disposed on the substrate and covering the light emitting diode; and
a constellation plate covering the diffusion member and including a blocking portion, which is opaque to light at a wavelength of light output from the diffusion member, and a plurality of transparent portions in the blocking portion, the transparent portions being at least partially transparent to the wavelength of light output from the diffusion member.

12. The planetarium apparatus of claim 11, wherein the transparent portions in the blocking portion are at positions corresponding to star positions.

13. The planetarium apparatus of claim 11, wherein the diffusion member is a dome shape.

14. The planetarium apparatus of claim 11, wherein the diffusion member is a hemispherical shape.

15. The planetarium apparatus of claim 11, wherein the diffusion member is a shape that is less than a full sphere, but greater than a hemisphere.

16. The planetarium apparatus of claim 11, wherein the diffusion member includes a plurality of protrusion portions and has a star shape when viewed from at least one direction.

17. The planetarium apparatus of claim 11, wherein the diffusion member includes a phosphor which absorbs light at the wavelength emitted by the light emitting diode and outputs light at a different wavelength.

18. The planetarium apparatus of claim 11, wherein the constellation plate is cylindrical.

19. A method of making a lighting apparatus, comprising:
mounting a light emitting diode on a substrate;
causing the substrate to have a hydrophobic surface; and
forming a diffusion member having a partial spherical outer surface to cover the light emitting diode mounted on the substrate by putting a resin having a contact angle, with respect to hydrophobic surface of the substrate, that is greater than 90 degrees on the light emitting diode mounted on the substrate, and then curing the resin.

20. The method of claim 19, further comprising:
placing a light shielding member over the diffusion member, the light shielding member having an opaque portion, which blocks light from the diffusion member, and a plurality of transparent portions, which transmit light output from the diffusion member, wherein positions of the transparent portions in the light shielding member correspond to star positions.
